(19) United States
(12) Patent Application Publication
(10) Pub. No.: US 2011/0094449 A1
(43) Pub. Date: Apr. 28, 2011

(54) BIRD FEEDER

(76) Inventor: Ervy George, Red Bluff, CA (US)

(21) Appl. No.: 12/906,464

(22) Filed: Oct. 18, 2010

Related U.S. Application Data
(60) Provisional application No. 61/255,175, filed on Oct. 27, 2009.

(51) Int. Cl. A01K 39/01

(52) U.S. Cl. 119/61.1

(57) ABSTRACT

A bird feeder includes a container having a feeding tray attached to one end, an end cap attached to the other, and a mounting device rigidly mounted to a surface. The bird feeder remains stable, even during adverse weather conditions.

### CROSS-REFERENCE TO RELATED APPLICATIONS

This application claims the benefit of Provisional Application No. 61/255,175 filed Oct. 27, 2009, the contents of which are incorporated herein by reference.

### BACKGROUND OF THE INVENTION

The present invention generally relates to a bird feeder. More specifically, the present invention relates to a bird feeder which is rigidly mounted to a surface.

Hummingbird feeders generally include a reservoir containing a sugar-water solution to feed hummingbirds and other birds. The bird accesses the sugar-water solution by orifices provided at the base of the reservoir. Current hummingbird feeders are hung on a vertical post or tree by using a hook or a chain. Unfortunately, these feeders move by the effects of the wind, causing the sugar-water solution to spill and splash out from the reservoir attracting insects. This problem often renders the feeder impractical, causing many owners to stop using them.

As can be seen, there is a need for a bird feeder that remains stable, even during adverse weather conditions.

### SUMMARY OF THE INVENTION

In one aspect of the present invention, the bird feeder according to the present invention includes a container having a feeding tray attached to one end, an end cap attached to the other end, a mounting device rigidly mounted to a surface, and the end cap includes at least one coupling device that interconnects with a corresponding coupling device of the mounting device.

In another aspect of the present invention, the bird feeder according to the present invention includes a container having a feeding tray attached to one end, an end cap attached to the other end, a mounting device rigidly mounted to a surface, the end cap includes at least one coupling device that interconnects with a corresponding coupling device of the mounting device, the mounting device includes a shaft and a crown and the crown includes the coupling device that interconnects with the coupling device of the end cap.

These and other features, aspects and advantages of the present invention will become better understood with reference to the following drawings, description and claims.

### BRIEF DESCRIPTION OF THE DRAWINGS

FIG. 1 illustrates a perspective front view of the bird feeder according to the present invention;

FIG. 2 illustrates an exploded perspective front view of the bird feeder of FIG. 1; and

FIG. 3 illustrates a cross section view taken along line 3-3 of the bird feeder of FIG. 1.

### DETAILED DESCRIPTION OF THE INVENTION

The following detailed description is of the best currently contemplated modes of carrying out exemplary embodiments of the invention.

The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a bird feeder adapted to be rigidly mounted to a surface.

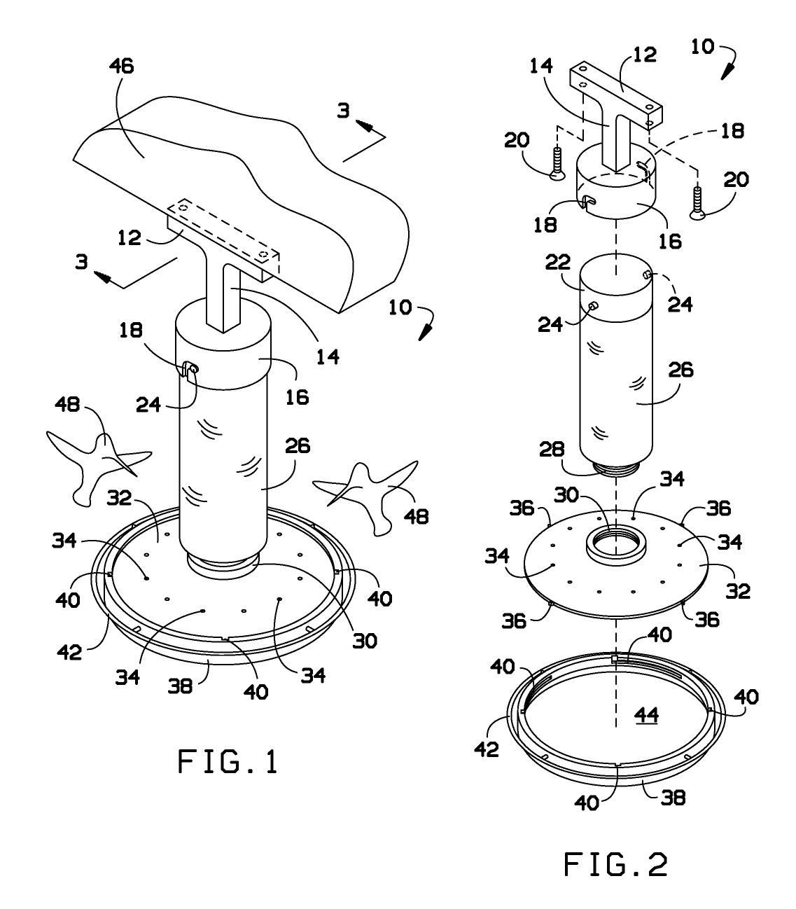

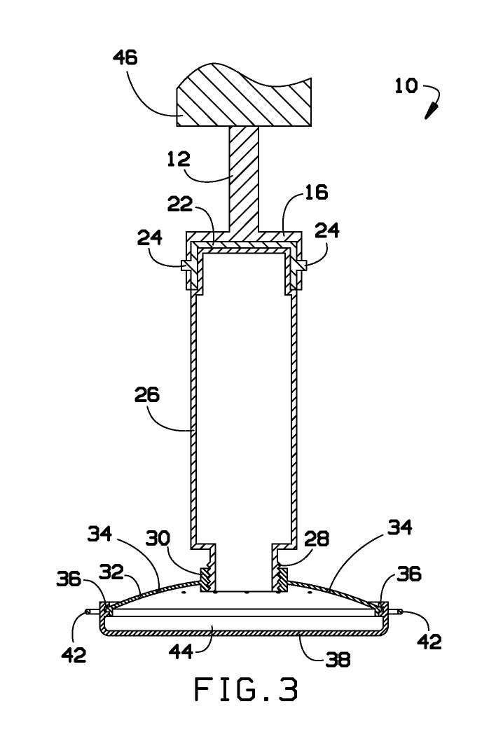

FIGS. 1-2 illustrates a bird feeder 10 according to the present invention. The bird feeder 10 may include a container 26 having a feeding tray 42 attached to one end and an end cap 22 attached to the other end. The end cap 22 may include a coupling device 24 designed to interconnect with a corresponding coupling device 18 on a mounting device 12. The mounting device 12 is adapted to be rigid mounted to the surface 46 by using fasteners 20.

The surface 46 may be a ceiling, a roof, or a tree. The container 26 may have a shape that allows the container 26 to hold the sugar-water solution. In one embodiment, the container has a cylindrical, oval, square, or rectangular shape. The container 26 may be made of a sturdy material. In one embodiment, the container 26 may be made of plastic or glass. The container 26 may include a closed end, an open end, and side walls. The side walls of the container 26 may have color or may be transparent. The open end of the container 26 may include threads 28 that may interconnect with the threads 30 of the feeding tray 42. The end cap 22 may be fixed to the closed end of the container 26. In one embodiment, the end cap 22 may be attached to the closed end of the container 26 by using magnets.

The feeding tray 42 may include a bottom plate 38 and a top plate 32. The top plate 32 may include a plurality of feeding ports 34 to permit a bird 48 to access the sugar-water solution. In addition, the top plate 32 may include at least one fastener 36 that may interconnect with a corresponding fastener 40 of the bottom plate 38.

The bottom plate 38 may include a bowl 44 to hold the sugar-water solution. The bottom plate 38 and the top plate 32 may be made of a hard smooth-surface material. In one embodiment, the top and bottom plates may be made of metal, plastic, or resin.

The mounting device 12 may include a shaft 14 and a crown 16. The shaft 14 may be made of a rigid material. In one embodiment, the shaft 14 may be made of metal, plastic, or resin. The shaft 14 may have different lengths, depending on a height of the surface 46 height. The shaft 14 may have a T-shape, a W-shape, an X-shape, or an S-shape.

The crown 16 may include the coupling device 18 that may interconnect with the coupling device 24 of the end cap 22. In one embodiment, the coupling devices 18 and 24 may be a groove and nipple combination.

The mounting device 12 may be a unitary piece device. The fasteners 20 may be screws, bolts, or nails. In one embodiment, the mounting device 16 may be welded or glued to the surface 46.

The user may attach the mounting device 12 to the surface 46. Then, the user may fill the container 26 with the sugar-water solution and may connect the container 26 with the feeding tray. The user may connect the end cap 16 with the mounting device 12 by interconnecting the coupling pieces 24 and 18. To refill the container 26, the user may disconnect the coupling pieces 24 and 18 and refill the container 26.

Having the bird feeder 10 rigidly attached to the surface 46 may prevent the bird feeder 10 from swinging, even in adverse weather conditions.

It should be understood, of course, that the foregoing relates to exemplary embodiments of the invention and that modifications may be made without departing from the spirit and scope of the invention as set forth in the following claims.

We claim:

1. A bird feeder comprising:
a container having a first end and a second end;
a feeding tray attached to the first end of the container;
an end cap attached to the second end of the container; and
a mounting device adapted to be mounted to a surface;
wherein the end cap includes at least one coupling device that interconnects with a corresponding coupling device of the mounting device.

2. The bird feeder of claim 1, wherein the mounting device is rigidly mounted to the surface by using fasteners.

3. The bird feeder of claim 1, wherein the mounting device is a unitary piece device.

4. The bird feeder according to claim 2, wherein the fasteners are selected from screws, bolts, and nails.

5. The bird feeder according to claim 1, wherein the mounting device is a unitary piece device.

6. The bird feeder according to claim 1, wherein the mounting device is welded or glued to the surface.

7. A bird feeder comprising:
a container having a first end and a second end;
a feeding tray attached to the first end of the container;
an end cap attached to the second end of the container; and
a mounting device adapted to be mounted to a surface;
wherein the end cap includes at least one first coupling device that interconnects with a corresponding second coupling device of the mounting device;
wherein the mounting device includes a shaft and a crown;
wherein the shaft is made of a rigid material; and
wherein the crown includes the second coupling device that interconnects with the first coupling device of the end cap.

8. The bird feeder of claim 7, wherein the first coupling device and the second coupling device are a groove and a nipple.

9. The bird feeder according to claim 7, wherein the mounting device is a unitary piece device.

10. The bird feeder according to claim 7, wherein the shaft 14 has a T-shape.
